(19) United States
(12) Patent Application Publication
(10) Pub. No.: US 2014/0025720 A1
(43) Pub. Date: Jan. 23, 2014

(54) SOLVING LINEAR EQUATION SYSTEMS WITH MULTIPLE RIGHT HAND SIDES BY KRYLOV SUBSPACE EXPANSION

(71) Applicant: NVIDIA CORPORATION, Santa Clara, CA (US)

(72) Inventor: Robert STRZODKA, Affoltern Am Albis (CH)

(21) Appl. No.: 13/931,706

(22) Filed: Jun. 28, 2013

Related U.S. Application Data
(60) Provisional application No. 61/672,487, filed on Jul. 17, 2012.

(51) Int. Cl. G06F 17/12

(52) U.S. Cl. CPC G06F 17/12
USPC 708/446

(57) ABSTRACT

One embodiment sets forth a method for solving linear equation systems that include the same matrix A coupled with multiple right-hand-side vectors. For each new right-hand-side vector, a solver expands an existing Krylov subspace based on the Krylov subspace and data associated with the previous right-hand-side vector. The solver then uses the expanded Krylov subspace to approximately solve the linear equation system for the new right-hand-side vector. By expanding the Krylov subspace for each new right-hand-side vector, the solver continually leverages the information from the preceding right-hand-side vectors. Advantageously, expanding the Krylov subspace is typically computationally quicker than prior art-techniques, such as creating a new Krylov subspace or transforming an existing Krylov subspace. Consequently, by implementing the disclosed techniques, the likelihood of exceeding time constraints associated with algorithms that include solving certain classes of linear equation systems may be decreased.

### CROSS-REFERENCE TO RELATED APPLICATIONS

This application claims benefit of U.S. provisional patent application Ser. No. 61/672,487, filed Jul. 17, 2012, which is hereby incorporated herein by reference.

### BACKGROUND OF THE INVENTION

1. Field of the Invention

The present invention generally relates to general purpose computing and, more specifically, to techniques for solving linear equation systems with multiple right hand sides by Krylov subspace expansion.

2. Description of the Related Art

Linear equation systems appear in many applications of scientific computing within a diverse range of fields, such as chemistry, structural analysis, physics, mathematics, etc. And solving such linear equation systems is an important part of many algorithms used in these fields, such as chemical processing simulation algorithms. As is well known, linear equation systems may be represented in matrix form as Ax=RHS. Often, the elements included in the linear equation systems exhibit similarities based on the type of problem. In particular, many practical problems lead to linear equation systems that include large, sparse A matrices. Notably, in a sparse matrix that includes N rows, the number of non-zero coefficients is (in Big O notation) O(N) rather than O(N²). Further, some linear equation systems that include the same large, sparse A matrix are used to solve systems with many different, but correlated right-hand-side vectors (RHS). However, for a large matrix A, determining the exact solution x for even one right-hand-side vector may require too much memory and too much time to be useful. Therefore, iterative techniques are used to generate an approximate solution.

In one approach to solving linear equation systems that include the same large matrix A coupled with multiple, correlated right-hand-side vectors, each right-hand-side vector is treated as an independent problem. For example, a Krylov iterative solver may be used to find an approximate solution x for each RHS separately. The Krylov iterative solver typically generates an initial guess at an approximate solution and constructs an orthonormal basis of the Krylov subspace created by the iterative solver from the initial residual (i.e., RHS−Ax). Subsequently, the Krylov iterative solver generates successive approximate solutions by minimizing the residual. For each iteration, the Krylov solver uses the available information, including the previous approximate solutions, to obtain a better new solution. The Krylov solver continues to iterate, incrementally minimizing the residual, until a pre-set time limit is exceed or until the residual is lower than a pre-defined value (i.e., an acceptable residual). To solve for a new right-hand-side vector, the Krylov iterative solver completely restarts the process. Notably, the Krylov iterative solver constructs a new orthonormal basis of a new Krylov subspace before solving for the new right-hand-side vector. One limitation to solving for each right-hand-side vector in this fashion is that constructing the basis of the associated Krylov subspace is typically very time-consuming. Consequently, when the application requires solving linear equations systems for many different right-hand-side vectors, treating each right-hand-side vector as an individual problem may exceed the time constraints of the application.

In another approach to solving linear equation systems that include the same large matrix A coupled with multiple, correlated right-hand-side vector s, the iterative solver transforms the initial Krylov subspace for each subsequent right-hand-side vector. In this approach, the iterative solver builds the initial orthonormal basis and corresponding Krylov subspace to solve for the first right-hand-side vector. Subsequently, to solve for a new right-hand-side vector, the iterative solver transforms the orthonormal basis and Krylov subspace. The solver then uses the transformed orthonormal basis and Krylov subspace to solve for the approximate x for the new right-hand-side vector. Similarly, for each new right-hand-side vector, the iterative solver performs transformations and then iterates to approximately solve for the new right-hand-side vector. When the right-hand-side vectors are closely correlated, using transformations instead of creating completely new Krylov subspaces decreases the time required to reach an acceptable level of precision. However, performing the transformations is still very time-consuming. And, despite the decrease in execution time, there are many applications where this approach still exceeds the time available.

As the foregoing illustrates, what is needed in the art is a more efficient technique for solving certain classes of linear equation systems with multiple right-hand-sides.

### SUMMARY OF THE INVENTION

One embodiment of the present invention sets forth a method for solving linear equation systems with a plurality of right-hand-side vectors. The method includes identifying a first linear equation system that includes a constant matrix, a variable to be solved, and a first right-hand-side vector; generating a first approximate solution to the first linear equation system based on a Krylov subspace; computing a first set of data related to the first right-hand-side vector; identifying a second linear equation system that includes the constant matrix, the variable to be solved, and a second right-hand-side vector; expanding the Krylov subspace based on the first set of data; and generating a second approximate solution to the second linear equation system based on the Krylov subspace.

Other embodiments of the present invention include, without limitation, a computer-readable storage medium including instructions that, when executed by a processing unit, cause the processing unit to implement aspects of the techniques described herein as well as a system that includes different elements configured to implement aspects of the techniques described herein.

By implementing the disclosed techniques, a solver program may leverage information derived from previous right-hand-side vectors of a linear equation system to decrease the time required to solve the linear equation system for subsequent right-hand-side vectors. In particular, by continually expanding a an orthornormal basis of the Krylov subspace for each new right-hand-side vector, the solver may solve linear equation systems for correlated right-hand-side vectors more efficiently than prior-art techniques. Consequently, the overall performance of certain software applications may be improved.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a is a conceptual diagram illustrating the solver and the builder of FIG. 1, according to one embodiment of the present invention;

FIG. 3 is a conceptual diagram illustrating a solver execution order and a builder execution order, according to one embodiment of the present invention;

FIG. 4 is a flow diagram of method steps for solving a linear equation system for different right-hand-side vectors, according to one embodiment of the present invention; and

FIG. 5 is a flow diagram of method steps for expanding an orthonormal basis of the Krylov subspace based on different right-hand-side vectors, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

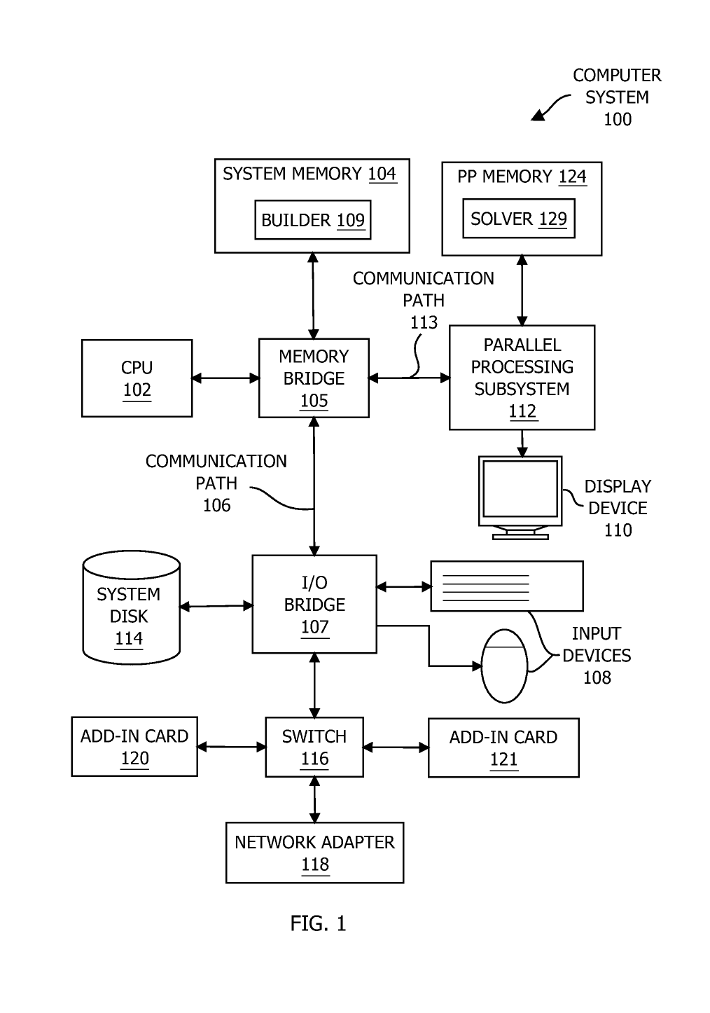

FIG. 1 is a block diagram illustrating a computer system 100 configured to implement one or more aspects of the present invention. As shown, the computer system 100 includes, without limitation, a central processing unit (CPU) 102 and a system memory 104 communicating via an interconnection path that may include a memory bridge 105. The memory bridge 105, which may be, e.g., a Northbridge chip, is connected via a bus or other communication path 106 (e.g., a HyperTransport link) to an I/O (input/output) bridge 107. The I/O bridge 107, which may be, e.g., a Southbridge chip, receives user input from one or more user input devices 108 (e.g., keyboard, mouse) and forwards the input to the CPU 102 via the communication path 106 and the memory bridge 105. A parallel processing subsystem 112 is coupled to the memory bridge 105 via a bus or second communication path 113 (e.g., a Peripheral Component Interconnect (PCI) Express, Accelerated Graphics Port, or HyperTransport link); in one embodiment parallel processing subsystem 112 is a graphics subsystem that delivers pixels to a display device 110 (e.g., a conventional cathode ray tube or liquid crystal display based monitor). A system disk 114 is also connected to the I/O bridge 107. A switch 116 provides connections between the I/O bridge 107 and other components such as a network adapter 118 and various add-in cards 120 and 121. Other components (not explicitly shown), including universal serial bus (USB) or other port connections, compact disc (CD) drives, digital video disc (DVD) drives, film recording devices, and the like, may also be connected to the I/O bridge 107. The various communication paths shown in FIG. 1, including the specifically named communication paths 106 and 113, may be implemented using any suitable protocols, such as PCI Express, AGP (Accelerated Graphics Port), HyperTransport, or any other bus or point-to-point communication protocol(s), and connections between different devices may use different protocols as is known in the art.

As shown, the parallel processing subsystem 112 is coupled to a local parallel processing (PP) memory 124. The parallel processing subsystem 112 and the parallel processing memory 124 may be implemented using one or more integrated circuit devices, such as programmable processors, application specific integrated circuits (ASICs), or memory devices, or in any other technically feasible fashion. As shown, the parallel processing subsystem 112 communicates with the rest of computer system 100 via the communication path 113, which connects to the memory bridge 105 (or, in one alternative embodiment, directly to the CPU 102). The connection of the parallel processing subsystem 112 to the rest of the computer system 100 may also be varied. In some embodiments, the parallel processing subsystem 112 is implemented as an add-in card that can be inserted into an expansion slot of the computer system 100. In other embodiments, the parallel processing subsystem 112 can be integrated on a single chip with a bus bridge, such as the memory bridge 105 or the I/O bridge 107. In still other embodiments, some or all elements of the parallel processing subsystem 112 may be integrated on a single chip with the CPU 102. In one embodiment, the communication path 113 is a PCI Express link. Other communication paths may also be used.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, the CPU 102, and the I/O bridge 107 to form a system on chip (SoC).

The parallel processing subsystem 112 may be provided with any amount of parallel processing memory 124 and may use the parallel processing memory 124 and the system memory 104 in any combination. The parallel processing subsystem 112 may transfer data from system memory 104 and/or the local parallel processing memory 124 into internal (on-chip) memory, process the data, and write result data back to system memory 104 and/or the local parallel processing memory 204, where such data can be accessed by other system components, including CPU 102 or another parallel processing subsystem 112.

In operation, the CPU 102 is the master processor of the computer system 100, controlling and coordinating operations of other system components, including the parallel processing subsystem 112. Advantageously, the parallel processing subsystem 112 may execute commands asynchronously relative to the operation of CPU 102. As shown, the system memory 104 includes a builder 109 that executes on the CPU 102 and the parallel processing memory 124 includes a solver 129 that executes on the parallel processing subsystem 112. The builder 109 and the solver 129 collaborate asynchronously to solve systems of linear equations with multiple right-hand-sides. By working together to efficiently utilize both the CPU 102 and the parallel processing subsystem 112, the builder 109 and the solver 129 optimize the time required to solve systems of linear equations. In alternate embodiments, the builder 109 and the solver 129 may execute on the CPU 102 and the parallel processing subsystem 112 in any combination. Further, the builder 109 and the solver 129 may be combined into a single program or decomposed into additional programs.

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, the system memory 104 is connected to the CPU 102 directly rather than through a bridge, and other devices communicate with the system memory 104 via the memory bridge 105 and the CPU 102. In other alternative topologies, the parallel processing subsystem 112 is connected to the I/O bridge 107 or directly to the CPU 102, rather than to the memory bridge 105. In still other embodiments, the I/O bridge 107 and the memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, the switch 116 is eliminated, and the network adapter 118 and the add-in cards 120, 121 connect directly to the I/O bridge 107.

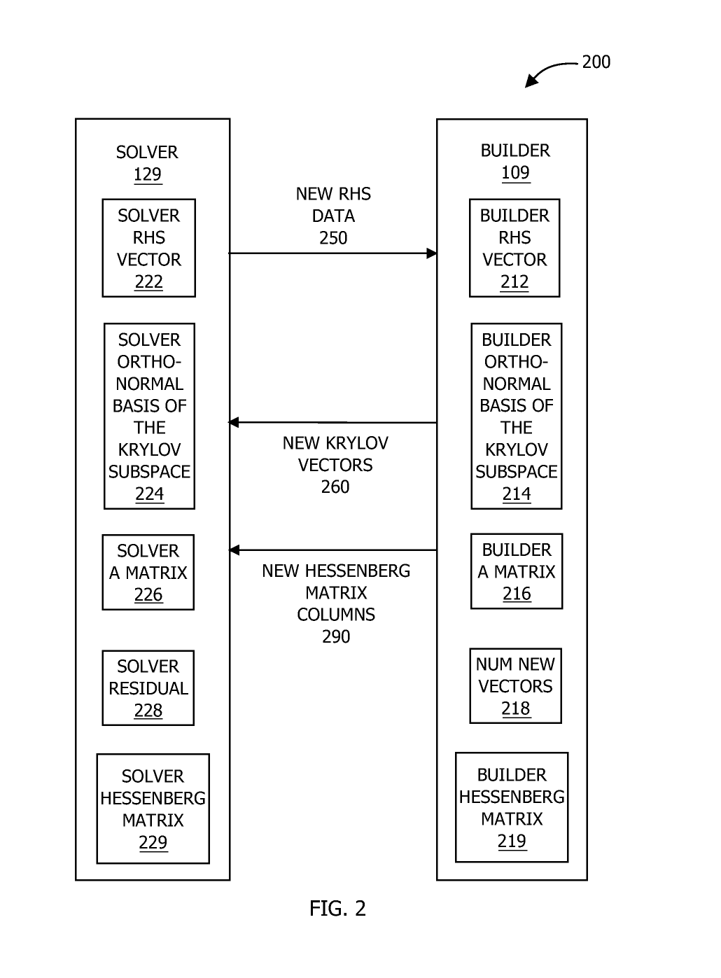

FIG. 2 is a conceptual diagram illustrating the solver 129 and the builder 109 of FIG. 1, according to one embodiment of the present invention. Together the solver 129 and the builder 109 are configured to solve linear equations systems for multiple right-hand-sides.

Linear equation systems may be represented in matrix form as Ax=RHS. As persons skilled in the art will understand, the bandwidth to copy from the system memory 104 to the parallel processing memory 124 and from the parallel processing memory 124 to the system memory 104 is limited. And the parallel processing memory 124 provides a much higher bandwidth to the execution engines included in the parallel processing subsystem 112 than the system memory 104 provides. As previously noted herein, the solver 129 executes within the parallel processing subsystem 112 and the builder 109 executes within the CPU 102. Therefore, to increase efficiency, the solver 129 and the builder 109 are configured to operate on localized data related to the linear equation systems. For instance, the solver 129 operates on data local to the solver 129, such as data residing in the parallel processing memory 124. As shown, the solver 129 includes a solver A matrix 226, a solver right-hand-side vector (RHS) 222, a solver orthonormal basis of a Krylov subspace 224, and a solver residual 228. And the builder 109 includes a builder A matrix 216, a builder right-hand-side vector (RHS) 212, a builder orthonormal basis of the Krylov subspace 214, and a number of new vectors (num new vectors) 218.

The solver 129 is configured to form multiple linear equation systems, each including the same solver A matrix 226 coupled with a different solver right-hand-side vector 222. In the embodiment shown, the solver A matrix 226 is typically large and sparse and the different solver right-hand-side vectors 222 are correlated. Consequently, the solver 129 and builder 109 are optimized to solve a particular class of problems that include large and sparse solver A matrices 226 coupled with correlated solver right-hand-side vectors 222. In alternate embodiments, the solver 129 and builder 109 may be tuned to solve different classes of problems and the characteristics of the elements of the linear equation systems may vary accordingly.

For each solver right-hand-side vector 222, the solver 129 uses the solver orthonormal basis of the Krylov subspace 224 in conjunction with the solver A matrix 226 to iteratively generate an approximate solution to the linear equation system corresponding to the solver right-hand-side vector 222. As part of generating the approximate solution, the solver 129 calculates the solver residual 228 to determine the quality of each intermediate solution in a series of intermediate solutions culminating in the approximate solution. As is well known in the art, the solver residual 228 for an intermediate solution xₖ is the magnitude of the residual vector (RHS−Axₖ). If xₖ is the exact solution, then the solver residual 228 is zero. In general, the smaller the solver residual 228, the closer the intermediate solution xₖ is to the exact solution. If the solver residual 228 is greater than a maximum allowable tolerance and a time limit is not exceeded, then the solver 129 is configured to generate another intermediate solution. Each successive intermediate solution is based on the available Krylov subspace information and further reduces the solver residual 228. If the solver residual 228 is less than the maximum allowable tolerance or the time limit is exceeded, then the solver 129 sets the approximate solution for the solver right-hand-side vector 222 to the current intermediate solution. The solver 129 then forms a new linear equation system with a new solver right-hand-side vector 222.

After the solver 129 has solved the linear equation system for the first solver right-hand-side vector 222, the solver forms a linear equation system including the same solver A matrix 226 coupled with a subsequent solver right-hand-side vector 222. In prior-art techniques for solving a linear equation system for additional right-hand-sides, a solver typically creates a new Krylov subspace or applies one or more transformations to an existing Krylov subspace. In contrast, the solver 129 is configured to more effectively leverage the information generated while solving the linear equation system for the previous solver right-hand-sides vector 222. More specifically, the solver 129 expands the solver orthonormal basis of the Krylov subspace 224 by receiving the new Krylov vectors 260 from the builder 109. Advantageously, reusing previous information by expanding the solver orthonormal basis of the Krylov subspace 224 may decrease the time required to solve the linear equation system for additional right-hand-side vectors 222. In particular, as the correlation between the various solver right-hand-side vectors 222 increases, the effectiveness of expanding the solver orthonormal basis of the Krylov subspace 224 also increases.

To further increase the effectiveness of expanding the solver orthonormal basis of the Krylov subspace 224, the processes of generating solutions and generating the new Krylov vectors 260 in the builder orthonormal basis of the Krylov subspace 214 are decoupled and executed in parallel. When the solver 129 forms a new solver right-hand-side vector 222, the solver 129 sends new right-hand-side (RHS) data 250 to the builder 109. Again, to increase efficiency, the builder 109 operates on data local to the builder 109. For instance, the builder 109 includes the builder A matrix 216 which is a copy of the solver A matrix 226. And, upon receiving the new right-hand-side (RHS) data 250, the builder 109 stores information included in the new right-hand-side data 250 as the builder right-hand-side vector 212. The new right-hand-side data 250 may include a variety of different types of data associated with the solver right-hand-side vector 222. The new right-hand-side data 250 associated with the initial solver right-hand-side vector 222 includes the initial solver right-hand-side vector 222. And the new right-hand-side data 250 associated with a subsequent solver right-hand-side 222 includes the orthogonal remainder of the projection of the solver right-hand-side vector 222 onto the solver orthonormal basis of the Krylov subspace 224.

The builder 109 continually creates new vectors based on the builder right-hand-side vector 212. And the builder 109 continually adds these new vectors to the builder orthonormal basis of the Krylov subspace 214, thereby expanding the builder orthonormal basis of the Krylov subspace 214. Further, the builder 109 sends these new vectors to the solver 129 as the new Krylov vectors 260. The builder 109 may create the new Krylov vectors 260 in any technically feasible fashion using any algorithm as known in the art. There is one necessary condition that the construction algorithm needs to fulfill to enable the solver 129 to subsequently compute an approximation to a linear equation system with a new solver right-hand-side vector 222. The new unit Krylov vector yₖ must be orthogonal to the builder orthonormal basis of the Krylov subspace 214, Azₖ must be contained in the extended builder Krylov subspace, where zₖ is an approximate solution created with some preconditioner of the matrix A. Further, the coefficients of the orthogonalization are included in a Hessenberg matrix. For instance, in some embodiments, the builder 109 approximately solves the system Ax=RHSₖ to obtain the zₖ vector and uses Gram-Schmidt orthogonalization on Azₖ and the builder orthonormal basis of the Krylov subspace 214 to obtain the orthogonalization coefficients hₖ. Subsequently, the builder 109 normalizes the orthogonal remainder to obtain a new Krylov vector yₖ. The builder 109 adds the new Krylov vector yₖ to the builder orthonormal basis of the Krylov subspace 214, the other auxiliary vector, zₖ, to the collection of approximate solutions to the linear equation system, and creates a new column in a builder Hessenberg matrix (H) 219 that includes the orthogonalization coefficients hₖ. The builder 109 sends the new column as new Hessenberg matrix columns 290 to the solver 129. Subsequently, the solver 129 adds the new Hessenberg matrix columns 290 to a solver Hessenberg matrix 229.

To facilitate independent and mutually beneficial efforts by the builder 109 and the solver 129, the builder orthonormal basis of the Krylov subspace 214 and the solver orthonormal basis of the Krylov subspace 224 contain the same vectors. However, the builder orthonormal basis of the Krylov subspace 214 can be bigger, because some new Krylov vectors have not been received by the solver 129 yet. Again, the builder 109 continually expands the builder orthonormal basis of the Krylov subspace 214. In operation, after the solver 129 sends the new right-hand-side data 250 to the builder 109, the solver 129 requests that the builder 109 send the number of new vectors 218 that the builder 109 has added to the builder orthonormal basis of the Krylov 214 subspace based on the previous new right-hand-side data 250. Although the solver 129 receives the new Krylov vectors 260 as the builder 109 generates new Krylov vectors, the solver 129 only incorporates the new Krylov vectors 260 into the solver orthonormal basis of the Krylov subspace 224 when the solver 129 creates a new solver right-hand-side vector 222. For example, suppose that the solver 129 were to send a fifth new right-hand-side data 250 to the builder 109. The solver 129 would then request the number of new vectors 218 from the builder 109. And the builder 109 would send the number of new vectors 218 that the builder 109 had completed creating since receiving the fourth new right-hand-side data 250. The solver 129 would then add the number of new vectors 218 from the new Krylov vectors 260 that the solver 129 had received since sending the fourth new right-hand-side data 250 to the solver orthonormal basis of the Krylov subspace 224.

After sending the number of new vectors 218 to the solver 129, the builder 109 resets the number of new vectors 218 to zero. And as the builder 109 adds completed vectors to the builder orthonormal basis of the Krylov subspace 214, the builder 109 increases the number of new vectors 218 correspondingly. Notably, the builder 109 does not increment the number of new vectors 218 until all the data associated with a particular vector has been transmitted as the new Krylov vectors 260. In this manner, the builder 109 ensures that the solver 129 does not add any partially transmitted vectors to the solver orthonormal basis of the Krylov subspace 224. In general, the number of new vectors 218 acts as a synchronization mechanism, enabling the solver 129 to maintain the solver orthonormal basis of the Krylov subspace 224 as a snap-shot of the builder orthonormal basis of the Krylov subspace 214 based on the previous solver right-hand-side vector 222. More specifically, the solver orthonormal basis of the Krylov subspace 224 represents a version of the subspace that does not include information derived using the most recently formed solver right-hand-side vector 222 of the current linear equation system. In contrast, the builder orthonormal basis of the Krylov subspace 214 represents a version of the subspace that includes information from the most recently formed solver right-hand-side vector 222 of the current linear equation system. Advantageous, coordinating the data in this manner reduces the dependencies between the builder 109 and the solver 129, thereby enabling the builder 109 to enhance the performance of the solver 129 asynchronously.

In alternative embodiments, the solver 129 and the builder 109 may be configured with a maximum amount of memory for the orthonormal basis of the Krylov subspace. If expanding the solver orthonormal basis of the Krylov subspace 224 or the builder orthonormal basis of the Krylov subspace 214 would exceed the maximum allowed memory, then the solver 129 and the builder 109 would cease expanding the solver orthonormal basis of the Krylov subspace 224 and the builder orthonormal basis of the Krylov subspace 214 respectively. In some embodiments, the solver 129 and the builder 109 would replace existing vectors included in the solver orthonormal basis of the Krylov subspace 224 and the builder orthonormal basis of the Krylov subspace 214 with the new Krylov vectors 260 generated by the builder 109. In other embodiments, the solver 129 would restart the process of solving the linear equation system for a new set of different solver right-hand-side vectors 222. The solver orthonormal basis of the Krylov subspace 224 and the builder orthonormal basis of the Krylov subspace 214 would be reset to an initial state. Subsequently, the builder 109 would resume expanding the builder subspace 214. And the solver 129 would resume solving linear equation systems for different solver right-hand-side vectors 222 based on the solver orthonormal basis of the Krylov subspace 224.

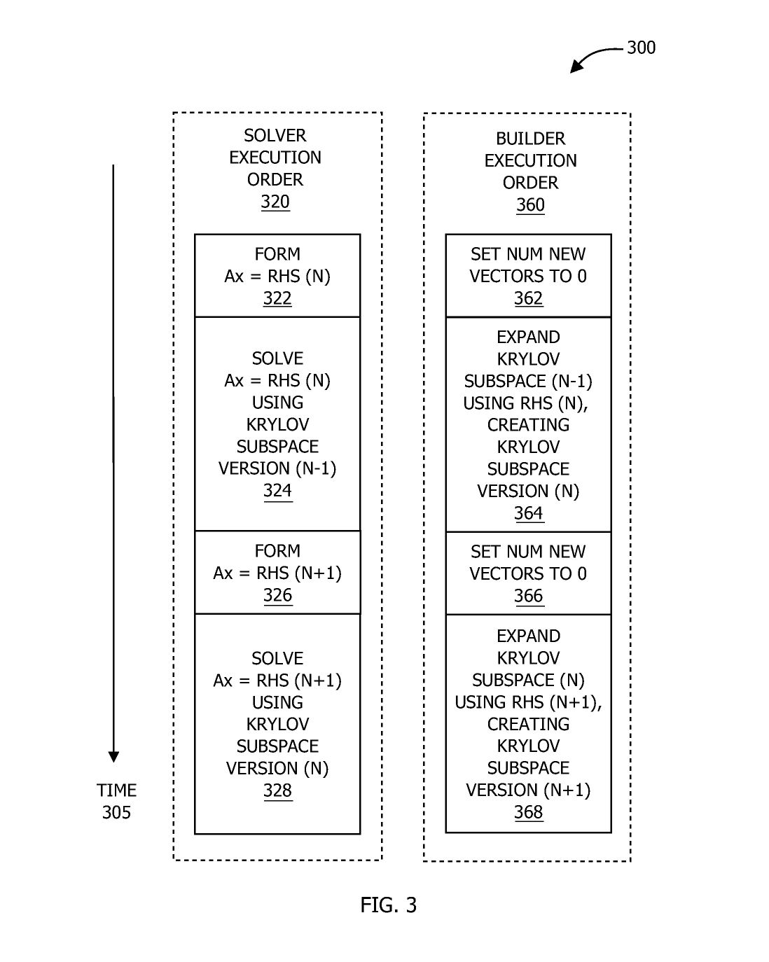

FIG. 3 is a conceptual diagram illustrating a solver execution order 320 and a builder execution order 360, according to one embodiment of the present invention. The solver execution order 320 corresponds to the execution order of the solver 129 within the parallel processing subsystem 112. And the builder execution order 360 corresponds to the execution order of the builder 109 within the CPU 102. As shown, FIG. 3 is organized sequentially by a time 305.

As shown, the solver 129 executes a set of commands “form Ax=RHS (N)” 322. As previously disclosed herein, after forming the N^{th} solver right-hand-side vector 222 for the linear equation system, the solver 129 send the new right-hand-side data 250 “RHS (N)” to the builder 109. Further, the solver 129 requests that the builder 109 send the number of new vectors 218 to the solver 129. Consequently, the builder 109 sends the number of new vectors 218 to the builder 109, and the builder 109 executes a command “set num new vectors to 0” 362.

The solver 129 then executes a set of commands “solve Ax=RHS (N) using subspace version (N−1)” 324. As part of performing this set of commands, the solver 129 expands the solver orthonormal basis of the Krylov subspace 224 to include the number of new vectors 218 that the solver 129 had previously received from the builder 109. Because these new vectors represent the new Krylov vectors 260 associated with the previous right-hand-side vector, RHS (N−1), the solver orthonormal basis of the Krylov subspace 224 now represents the subspace version (N−1). The solver 129 then iteratively solves for Ax=RHS (N). In parallel, the builder 109 executes a set of commands “expand Krylov subspace (N−1) using RHS (N), creating (the orthonormal basis of the) Krylov subspace version (N)” 364. As part of executing this set of commands, the builder 109 creates the new Krylov vectors 260 associated with the builder RHS vector 212 “RHS (N).” Further, the builder 109 increments the number of new vectors 218 appropriately, sends the new Krylov vectors 260 to the solver 129, and expands the builder orthonormal basis of the Krylov subspace 214 to include the new vectors.

After the solver 129 generates an approximate solution for Ax=RHS, the solver 129 executes a set of commands “form Ax=RHS (N+1)” 326. And the builder 109 executes the command “set num new vectors to 0” 366. The solver 129 then executes a set of commands “solve Ax=RHS (N+1) using Krylov subspace version (N)” 328. In parallel, the builder 109 executes a set of commands “expand Krylov subspace (N) using RHS (N+1), creating Krylov subspace version (N+1)” 368.

The solver 129 and the builder 109 continue to cooperate in this fashion (not shown). In general, the solver 129 generates solutions for the solver right-hand-side vector 222 using a snap-shot of the builder orthonormal basis of the Krylov subspace 214 (i.e., the solver orthonormal basis of the Krylov subspace 224) which does not include the new Krylov vectors 260 associated with the solver right-hand-side vector 222. And in a parallel effort, the builder 109 expands the builder orthonormal basis of the subspace 214 to include new subspace data associated with the solver right-hand-side vector 222.

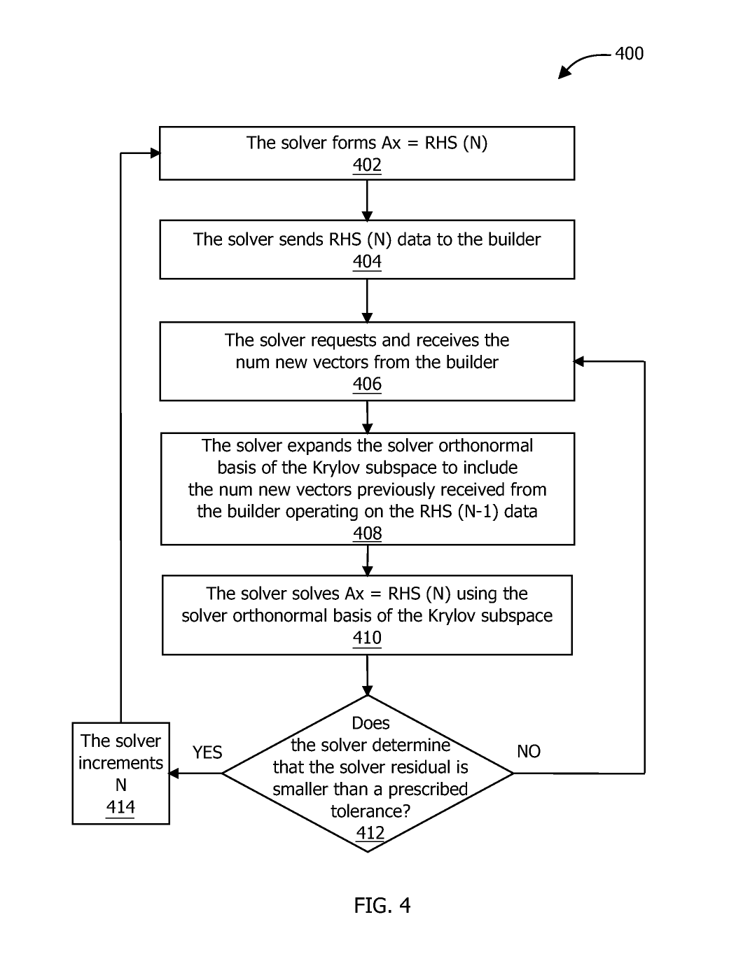

FIG. 4 is a flow diagram of method steps for solving a linear equation system for different right-hand-sides, according to one embodiment of the present invention. Although the method steps are described with reference to the systems of FIGS. 1-3, persons skilled in the art will understand that any system configured to implement the method steps, in any order, falls within the scope of the present invention.

As shown, a method 400 begins at step 402, where the solver 129 forms a linear equation system Ax=RHS (N), where A is the solver A matrix 226 and RHS (N) is the N^{th} solver right-hand-side vector 222 generated by the solver 129. For example, if N were 3, then the solver 129 would have solved the linear equation system for 2 previous values of the solver right-hand-side vector 222 (N=1 and N=2). As part of step 402, the solver 129 sets the solver right-hand-side vector 222 to equal RHS (N). At step 404, the solver 129 sends the new right-hand-side data 250 (i.e., the data associated with the RHS (N)) to the builder 109. As outlined previously herein, the new right-hand-side data 250 may include a variety of information related to the RHS (N). Further, the type of information included in the new right-hand-side data 250 may vary based on N.

At step 406, the solver 129 requests that the builder 109 send the number of new vectors 218 to the solver 129. As detailed previously herein, the builder 109 is configured to send the new Krylov vectors 260 to the solver 129 while the builder 109 is expanding the builder orthonormal basis of the Krylov subspace 214. However, to ensure that the builder 109 does not operate on incomplete new Krylov vectors 260, the builder 109 uses the number of new vectors 218. In particular, the number of new vectors 218 serves as a counter of the vectors that the builder 109 has finished creating since the solver 129 last requested the number of new vectors 218. At step 408, the solver 129 expands the solver orthonormal basis of the Krylov subspace 224 to include data from the appropriate number of new vectors 218 included in the new Krylov vectors 260 previously received but not yet included in the solver orthonormal basis of the Krylov subspace 224. In this fashion, the solver 129 maintains the solver orthonormal basis of the Krylov subspace 224 as a snap-shot of the builder orthonormal basis of the Krylov subspace 214 corresponding to the previous solver right-hand-side vector 222 “RHS (N−1).”

At step 410, the solver 129 solves the linear equation system Ax=RHS (N) using the orthonormal basis of the solver orthonormal basis of the Krylov subspace 224 and the solver Hessenberg matrix 229. As part of step 410, the solver 129 projects the solver RHS vector 222 onto the solver orthonormal basis of the Krylov subspace 224 to obtain a decomposition into a part that lies within the solver orthonormal basis of the Krylov subspace 224 and an orthogonal remainder. The solver 129 minimizes the part of the decomposition that lies within the solver orthonormal basis of the Krylov subspace 224 by solving a least-square-problem with the coefficients of the projection as the solver right-hand-side vector 222 and the solver Hessenberg matrix 229 provided by the builder 109. Notably, the builder 109 sends the new Hessenberg matrix columns 290 to the solver 129 in conjunction with the new Krylov vectors 260. In solving the least-square-problem, the solver 129 determines which linear combination of the stored zₖ vectors minimizes this part of the solver RHS vector 222. The solver 129 may solve the least-square-problem with the solver Hessenberg matrix 229 in any technically feasible fashion, for example with Gauss elimination. At step 412, if the solver determines that the solver residual 228 is not smaller than a prescribed tolerance, then the method 400 proceeds to step 406. The solver 129 cycles through steps 406 through 412, performing Krylov iterations to create approximate solutions for the solver right-hand-side vector 222, until the solver 129 determines that the solver residual 228 is smaller than the prescribed tolerance.

At step 412, if the solver 129 determines that solver residual 228 is smaller than the prescribed tolerance, then the method 400 proceeds to step 414. At step 414, the solver increments N. The solver 129 cycles through steps 402 through 414, forming and solving the linear equation system for additional solver right-hand-side vectors 222.

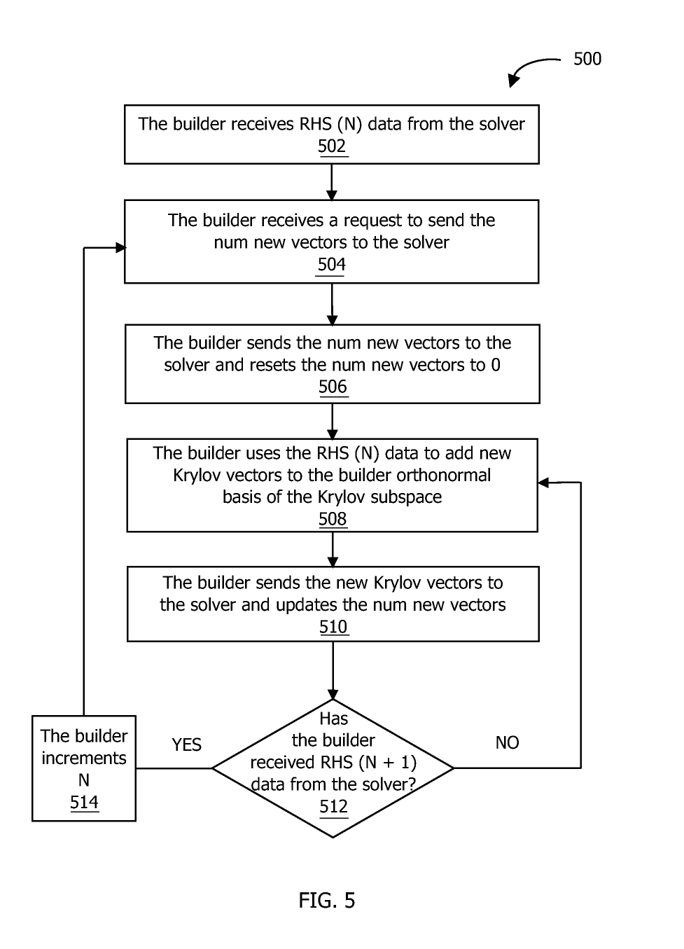

FIG. 5 is a flow diagram of method steps for expanding an orthonormal basis of the Krylov subspace based on different right-hand-side vectors, according to one embodiment of the present invention. Although the method steps are described with reference to the systems of FIGS. 1-3, persons skilled in the art will understand that any system configured to implement the method steps, in any order, falls within the scope of the present invention.

As shown, a method 500 begins at step 502, where the builder 109 receives new right-hand-side data 250 corresponding to RHS (N) from the solver 129. The new right-hand-side data 250 is part of the linear equation system Ax=RHS (N), where A is the builder A matrix 216 and the RHS (N) is the right-hand-side related to the N^{th} new right-hand-side data 250 received by the builder 109. As part of step 502, the builder 109 sets the builder right-hand-side vector 212 to the RHS (N) corresponding to the new right-hand-side data 250. At step 504, the builder 109 receives a request from the solver 129 to send the number of new vectors 218 to the solver 129. At step 506, the builder 109 sends the number of new vectors 218 to the solver 129. The builder 109 then resets the number of new vectors 218 to zero. By resetting the number of new vectors 218, the builder 109 establishes a new number of new vectors 218 base-line. This allows the builder 109 to use the number of new vectors 218 to represent the number of new Krylov vectors that the builder 109 has completed creating since the solver 129 last requested that the builder 109 send the number of new vectors 218.

At step 508, the builder 109 uses the builder right-hand-side vector 212 (corresponding to RHS (N)) to add new vectors to the orthonormal basis of the builder orthonormal basis of the Krylov subspace 214, thereby expanding the builder orthonormal basis of the Krylov subspace 214. As outlined previously herein, the builder 109 may create the new Krylov vectors 260 in any technically feasible fashion using any algorithm as known in the art that fulfills the condition described in conjunction with FIG. 2. At step 510, the builder 109 sends the new Krylov vectors 260 to the solver 129 and adds the number of new vectors sent to the solver 129 to the number of new vectors 218. For example, suppose that the new vectors were to include the new auxiliary vector pair (yₖ, zₖ). The builder 109 would send the auxiliary vector pair (yₖ, zₖ) to the solver 129 and, subsequently, the builder 109 would add 2 to the number of new vectors 218. At step 512, if the builder 109 determines that the builder 109 has not received new right-hand-side data 250 corresponding to RHS (N+1) from the solver 129, then the method 500 returns to step 508.

The builder 109 continues to execute steps 508 through 512, adding vectors to the builder orthonormal basis of the Krylov subspace 214 based on the builder right-hand-side vector 212 “RHS (N)” and sending the new Krylov vectors 260 to the solver 129, until the builder 109 receives new right-hand-side data 250 from the solver 129. If, at step 512, the builder 109 determines that the builder has received new right-hand-side data 250 corresponding to RHS (N+1) from the solver 129, then the method 500 proceeds to step 514. At step 514, the builder 109 increments N, and the method 500 returns to step 504. The builder 109 cycles through steps 504 through 514, adding vectors to the builder orthonormal basis of the Krylov subspace 214 based on the most recently received new right-hand-side data 250 and sending the new Krylov vectors 260 to the solver 129.

In sum, solving linear equation systems that include the same large matrix A coupled with multiple, correlated right-hand-side vectors may be more efficiently implemented by using incrementally expanding Krylov subspaces. In one embodiment, a solver program executing on a parallel processing subsystem and a builder program executing on a CPU collaborate asynchronously to reduce the time required to solve for each right-hand-side vector (RHS). For each RHS, the solver forms the linear equation Ax=RHS. The solver sends data associated with the RHS to the builder and requests the number of new Krylov vectors that the builder has generated since receiving the previous RHS. The solver then expands the orthonormal basis of the solver Krylov subspace to include the number of new vectors (based on the previous RHS) and approximately solves Ax=RHS based on the expanded solver Krylov subspace. The solver continues in this fashion, solving the linear equations systems for each new RHS after expanding the orthonormal basis of the solver Krylov subspace based on new vectors generated by the builder from data associated with the previous RHS. In parallel, the builder is continually adding vectors to the orthonormal basis of the builder Krylov subspace using the data associated with the most recent RHS that the builder has received from the solver. As the builder adds Krylov vectors, the builder also transmits these vectors to the solver. Because the solver does not incorporate new vectors immediately, the orthonormal basis of the solver Krylov subspace represents a snap-shot of the orthonormal basis of the builder Krylov subspace based on the previous RHS. Consequently, the solver and the builder may operate efficiently in parallel without unnecessarily waiting for each other.

Advantageously, continuously expanding the Krylov subspace for each new right-hand-side vector is typically computationally faster than either creating a new Krylov subspace or transforming an existing Krylov subspace. Further, as persons skilled in the art will recognize, the more correlation between the right-hand-side vectors, the more effective the expanded Krylov subspace becomes for generating approximate solutions. And by using the disclosed asynchronous collaboration strategy to solve the linear equation systems, the time required to solve the linear equation systems is further optimized. Consequently, applications that exceed acceptable execution times using prior-art techniques may achieve acceptable performance using the disclosed techniques.

While the foregoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of the present invention is determined by the claims that follow.

What is claimed is:

1. A method for solving linear equation systems with a plurality of right-hand-side vectors, the method comprising:
identifying a first linear equation system that includes a constant matrix, a variable to be solved, and a first right-hand-side vector;
generating a first approximate solution to the first linear equation system based on a Krylov subspace;
computing a first set of data related to the first right-hand-side vector;
identifying a second linear equation system that includes the constant matrix, the variable to be solved, and a second right-hand-side vector;
expanding the Krylov subspace based on the first set of data; and
generating a second approximate solution to the second linear equation system based on the Krylov subspace.

2. The method of claim 1, wherein generating the first approximate solution comprises:
generating an intermediate solution based on the Krylov subspace;
computing the residual of the intermediate solution; and
reducing the residual of the intermediate solution to generate the first approximate solution.

3. The method of claim 1, wherein the first set of data includes a first set of vectors that is derived from the first right-hand-side vector and the Krylov subspace.

4. The method of claim 1, wherein the Krylov subspace is expanded without applying any transformation operations to the Krylov subspace.

5. The method of claim 1, further comprising:
determining that an orthonormal basis of the Krylov subspace does not exceed a maximum size;
computing a second set of data related to the second right-hand-side vector; and
expanding the Krylov subspace based on the second set of data.

6. The method of claim 1, further comprising:
determining that an orthonormal basis of the Krylov subspace exceeds a maximum size;
computing a second set of data related to the second right-hand-side vector; and
replacing at least a portion of the data included in the orthonormal basis of the Krylov subspace based on the second set of data.

7. The method of claim 1, wherein the first set of data includes one or more vectors not included in an orthonormal basis of the Krylov subspace.

8. The method of claim 1, wherein one or more operations related to computing the first set of data and one or more operations related to generating the first approximate solution occur substantially in parallel.

9. A computer-readable storage medium including instructions that, when executed by a processing unit, cause the processing unit to solve linear equation systems with a plurality of right-hand-side vectors by performing the steps of:
identifying a first linear equation system that includes a constant matrix, a variable to be solved, and a first right-hand-side vector;
generating a first approximate solution to the first linear equation system based on a Krylov subspace;
computing a first set of data related to the first right-hand-side vector;
identifying a second linear equation system that includes the constant matrix, the variable to be solved, and a second right-hand-side vector;
expanding the Krylov subspace based on the first set of data; and
generating a second approximate solution to the second linear equation system based on the Krylov subspace.

10. The computer-readable storage medium of claim 9, wherein generating the first approximate solution comprises:
generating an intermediate solution based on the Krylov subspace;
computing the residual of the intermediate solution; and
reducing the residual of the intermediate solution to generate the first approximate solution.

11. The computer-readable storage medium of claim 9, wherein the first set of data includes a first set of vectors that is derived from the first right-hand-side vector and the Krylov subspace.

12. The computer-readable storage medium of claim 9, wherein the Krylov subspace is expanded without applying any transformation operations to the Krylov subspace.

13. The computer-readable storage medium of claim 9, further comprising:
determining that an orthonormal basis of the Krylov subspace does not exceed a maximum size;
computing a second set of data related to the second right-hand-side vector; and
expanding the Krylov subspace based on the second set of data.

14. The computer-readable storage medium of claim 9, further comprising:
determining that an orthonormal basis of the Krylov subspace exceeds a maximum size;
computing a second set of data related to the second right-hand-side vector; and
replacing at least a portion of the data included in the orthonormal basis of the Krylov subspace based on the second set of data.

15. The computer-readable storage medium of claim 9, wherein the first set of data includes one or more vectors not included in an orthonormal basis of the Krylov subspace.

16. The computer-readable storage medium of claim 9, wherein one or more operations related to computing the first set of data and one or more operations related to generating the first approximate solution occur substantially in parallel.

17. A system configured to solve linear equation systems with a plurality of right-hand-side vectors, the system comprising:
a solver program configured to:
identify a first linear equation system that includes a constant matrix, a variable to be solved, and a first right-hand-side vector;
generate a first approximate solution to the first linear equation system based on a Krylov subspace;
compute a first set of data related to the first right-hand-side vector;
identify a second linear equation system that includes the constant matrix, the variable to be solved, and a second right-hand-side vector;
expand the Krylov subspace based on the first set of data; and
generate a second approximate solution to the second linear equation system based on the Krylov subspace.

18. The system of claim 17, wherein the first set of data includes a first set of vectors that is derived from the first right-hand-side vector and the Krylov subspace.

19. The system of claim 17, wherein the Krylov subspace is expanded without applying any transformation operations to the Krylov subspace.

20. The system of claim 17, wherein one or more operations related to computing the first set of data and one or more operations related to generating the first approximate solution occur substantially in parallel.
